(19) United States
(12) Patent Application Publication
(10) Pub. No.: US 2002/0087616 A1
(43) Pub. Date: Jul. 4, 2002

(54) Distributed interactive content system

(76) Inventor: Peter Garsoe, Portland, ME (US)

Correspondence Address: Chris A. Caseiro, Pierce Atwood, One Monument Square, Portland, ME, 04101, US

(21) Appl. No.: 09/737,933

(22) Filed: Dec. 15, 2000

Related U.S. Application Data
(60) Provisional application No. 60/171,030, filed on Dec. 16, 1999.

(51) Int. Cl. G06F 15/16

(52) U.S. Cl. 709/201; 709/219

(57) ABSTRACT

A system to enable the distribution of interactive content through a computer network. The system includes software to establish a storage and command structure for gathering, storing, and manipulating information associated with an array of subject matters. The information populates a unitary accessible content. The information may, for example, include forum-based communications made available to users through hosts. A transactional server effects the replication of posted information substantially upon posting such that all users accessing the content receive the updated information. Via links may be employed to automatically identify the source of a posting. The system enables filtering, administration, and/or monitoring of the content via the hosts. The system also includes an optional website and mini-page development sub-system that enables application of stored content information directly on a user's or a host's website with minimal indication of origin.

### CROSS-REFERENCE TO RELATED APPLICATION

This application claims the priority benefit of U.S. provisional application serial No. 60/171,030, filed Dec. 16, 1999, of the same title and by the same named inventor. The contents of that application are incorporated herein by reference.

### BACKGROUND OF THE INVENTION

1. Field of the Invention.

The present invention relates to network-based communication structures. More particularly, the present invention relates to systems for organizing and coordinating content associated with selectable content fields and making that content readily available and modifiable, possibly with some restrictions, by content viewers. Specifically, the present invention is a transparent system to enable computer-device-based users to interact with other users and network hosts, such as Internet web sites, to access the content and interact with it.

2. Description of the Prior Art.

The way the amorphous computer-interconnection array identified by the generic term “the Internet” currently operates is relatively inefficient. An individual with a computer and modem, wireless, or other transceiving linkage sub-system, may connect to other computing systems having similar linkage sub-systems by way of one or more network portals or hosts. In this way, any information of interest may be passed from one computing device to another. In fact, any one computer device location can operate as a unique information provider site. The type of information that may be made available via Internet connections is almost limitless. The information may be based in technology, education, culture, entertainment, commerce, etc. It may be public or relatively private. In all cases, however, the objective is to convey information from one location to another. As a result, all computing networks may experience similar limitations and problems to varying degrees.

Unfortunately, with all the disparate sources for computer-deliverable information, there is often considerable difficulty in discovering particular information of interest. There are many Internet-/web-searching systems, such as Yahoo™, Google™, and HotBot™, among others, intended to facilitate information discovery. They all generally require the user to input certain key search words and/or phrases intended to elicit specific web site addresses apparently related to such search words or phrases. It is a fairly common occurrence for the user to be bombarded with dozens, hundreds, and sometimes thousands of returned web site addresses to review. Some of the search results may be duplicative, they may be completely unrelated to the search request, and they can otherwise make the search effort fruitless or unacceptably tedious. For these reasons, among others, the Internet is presently comprised of relatively isolated pockets of information of varying degrees of value.

There are two primary problems associated with the current interactive model of the Internet and the search failings noted above. First, users may be less inclined to communicate via such computer linkages absent knowledge of a specific web site address for a particular information supplier of interest. They may be frustrated by either the inability to find a site of interest, or by the overwhelming number of sites returned by a search. This problem may be of particular concern when dealing with already skeptical users. Second, the suppliers of web-based information may be unable to communicate effectively with information seekers having an interest in the information made available by such suppliers. For example, a new supplier of surgical instruments may wish to communicate to surgeons information regarding new devices available from the supplier. Absent common knowledge of the supplier's address, many surgeons having access to the Internet can easily miss the source of information regarding the new devices.

In addition to the difficulty in wading through the wide array of web site locations, there is the inconvenience associated with moving from one site to another. Currently, if one discovers a plurality of web site addresses in a search, the user must jump back and forth between a selected site and the original search location, or from one site of interest to another, in order to collect all of the information of interest. The process can be relatively slow and subject to incomplete linkages from one to site to another. The causes of such obstacles can be as varied as the number of individual service providers in existence.

One way for computer-based interaction among savvy computer users having common interests is the Internet-based forum. A service provider or host may develop an interactive forum web site that acts much like a clearinghouse of information transmitted and received by site users. The forum is based on common interests of its users and it allows those users, in a relatively limited way, to exchange information with one another on subjects of common interest. The host acts as a conduit or portal and, sometimes, a filter for the conveyance of the information between the forum site members. Members submit questions or statements for review by other members. Subsequent responses by viewing members are attached to each question/statement so that interactions are logged on in a cumulative manner for all members to observe. The forum is established on one host site and the interested users must specifically access that particular site to view the content thereof.

Entities that establish web sites may include localized forums for their visitors in the hope that traffic to their sites will expand. In order to gain visitors, it may be necessary for such entities to purchase access to other forums, or to establish links to other hosts they believe are visited by relevant users. This can be a hit-or-miss and costly proposition. Additionally, or alternatively, such entities must provide enough “content” (useful information) on their sites to ensure adequate visitor traffic. Developing and/or purchasing such content (postings, graphics, source information, articles, etc.) can also be costly, as well as time consuming. Moreover, it is in a host's interest to ensure that the content be updated frequently to ensure retention of repeat visitor traffic. Most hosts do not have the time, capacity, or capability to update content information, particularly at the rate site viewers may expect.

In general, forums can be efficient ways to communicate information, raise questions on matters of interest to the forum members, etc. Again, however, difficulties in tracking down informational sites of interest apply as well to forum interfaces. Further, the information available from one forum may be out-dated, inaccurate, incomplete, etc. In addition, it is to be noted that there are pockets of forums, many duplicating the same areas of interest, that are not organized in any easily accessible fashion. Such dispersed forums, their users, and their providers would benefit greatly from coordination of information access sites.

The disparate array of web site hosts and services that enable network users to access information of interest naturally leads to limitations regarding the complete, accurate, and efficient exchange of that information. As a result, users may be frustrated and less inclined to seek such information by way of networks, particularly including the Internet. Importantly, this arrangement also limits information providers' ability to access audience members of interest.

Therefore, what is needed is a system for effectively distributing information via computer networking. What is also needed is a system through which content of interest can be accessed by information seekers or site users through information hosts of choice. Further, what is needed is an organized content-based distribution system that establishes for hosts sufficient up-to-date content to introduce into their own web sites. Still further, what is needed is such a system that allows visitors to access through any associated host site common content, which content may be modified by any party accessing the content.

### SUMMARY OF THE INVENTION

It is an object of the present invention to provide a system for distributing uniform information or content via computer networking, whether that network is relatively localized, spread throughout specified regions, or part of the global computer network. It is also an object of the present invention to provide a system through which content of interest can be accessed by information seekers or users through selectable information portals or hosts. Further, it is an object of the present invention to provide an organized content-based distribution system that establishes for hosts sufficient up-to-date content to introduce into their own web sites. Still further, it is an object of the present invention to provide a system that allows visitors to access through any associated host site common content. That content may be modified by, or otherwise made interactive with, users.

These and other objects are achieved in the present invention through the formation of a distributed interactive content system. The system includes means, primarily software, to enable storage, distribution, interaction, and manipulation of content (also referred to herein as information) associated with essentially any subject matter of interest. By way of example only, the content may be forum-based communications among users, which communications are archivable and are distributable to any user interested in accessing it. The content may also be any other type of information that may be of interest to users including, but not limited to, job postings, news, supplier data, and so on.

The system links users together through host sites to the content such that anyone interested in accessing the content sees common content on any one of one or more subjects of interest. That is, the content is uniform and that which is observed via one host is the same as the content observed via another host. That is distinct from what exists today, wherein there may be pockets of content sources, many of which are related to the same subject but which do not have exactly the same content. A central transactional server is used to effect the replication of the uniform content to all sites that may be accessed by users. The transactional server may also provide for storage of the content, either at a single location on a single computing device. Alternatively, it may be decentralized in that it may effect retention and accessing of portions of content via one or more individual sites. The transactional server may optionally be a host as well.

The software of the present invention is configured to enable retention of the content, to enable its access by one or more portals or hosts, and to enable users to access the content from one or more hosts. The software is configured to permit users to access those portions of the content of one or more particular subject matters of interest from one or more hosts that may include other users as well as the transactional server. As indicated, the transactional server may be, in effect, a single computing device. Alternatively, it may be any networking scheme or suitable form of information exchange. The software is configured to enable content accessors or users to interact with the content, such as by communication with other users via hosts, and to modify the content by adding, changing, or removing portions of the content. When an accessor manipulates that content, the content is essentially immediately updated by replication so that all other users will be able to observe the change.

In one embodiment of the invention, the software is configured to make it possible to integrate content, preferably managed by a primary regulator such as the primary transactional server, on or within the context of, a host's established web site. By all appearances, the host site appears as established by the host and it further includes the uniform content. The content, such as a forum of particular subject matter for example, is accessed by a user through a host site without openly appearing to pass the user through to the primary server. Instead, the user appears to remain at the third party's site to access the content. Regardless of the particular site from which the user begins, he/she can access the content of interest. Any other hosts associated with or subscribing to that particular content may optionally be accessed by that user upon engaging with or interacting with the content. In that way, users having interest in particular subject matter are able to communicate with others having the common interest.

As earlier noted, in addition to providing a means to access common content through any associated host, the distributed interactive content system of the present invention permits content visitors or users to interact with the content, exchange information with the content, and otherwise aid in the evolution of the content. That updated or modified content is immediately accessible to all other content users. Therefore, site hosts have a site that is updated each time the content is accessed and modified by any other party at any other host. The site host can therefore be sure that it provides the most up-to-date information associated with the content.

It is to be understood that the uniform content enabled by the software of the present invention may include, but is not limited to, forum exchanges, a library of articles, directories, news services, publications, notices, on any subject matter that may be of interest to any user. The software is configured such that the content, whether centralized, distributed, or some combination thereof, is searchable and preferably updated essentially immediately to ensure current information for users. As noted, that updating occurs when users accessing the content via a host post messages, responses, or in general terms, information. That new information is then reflected by the system to all hosts upon posting.

As a business tool, the distributed interactive content system of the present invention provides web hosts with access to content of particular interest to that host's visitors. For a relatively small investment, these hosts are readily accessible to relevant users. The content that may appear as a component of a host's site gives that host immediate access to a wealth of up-to-date information that would be difficult for the host to create alone. In addition to being a content accessing and manipulation mechanism, the software of the present invention is application related. Specifically, it is configured to permit a site host to administer, modify, or otherwise filter the content accessed and observed via that site. The software enables a host to require subscription for access to the site containing the content and/or to regulate what sort of content changes can be observed via that site. That is, a host can block entry of a content exchange onto that particular site or the posting of that entry once received. For example, if the content is a forum for an exchange among users, the software enables the host of a site through which that forum may be accessed to block entry on that particular site, any message that may be disparaging to the site. Alternatively, that host may block posting of a disparaging message. In effect, the host can filter out the transmission of such a message via its site, although not via other sites it does not administer. Additionally, the software is configured to enable a host to generate its own content set, or a content subset of a more expansive content set on any subject matter it desires.

The present invention further optionally provides a system to improve the process by which users discover information associated with a directory or list. Currently, a typical network-based search, such as through Google™ or Altavista™, for example, returns a plurality of site “hits” that requires the user to access each site, evaluate the site, and then return to the search results for the next site to evaluate. A “robot” effects the search and returns to the user's browser a directory or list that should be associated with the search request. Unfortunately, there is a reasonable likelihood that the same site will be returned more than once or that completely irrelevant sites will be discovered and unnecessarily observed. This can be terribly time consuming and frustrating. Moreover, when a list object is accessed, observation of the list is not possible.

The present invention facilitates access to relevant information associated with a directory or list of objects developed by search or otherwise. Specifically, it provides a progressive directory access scheme. The improved directory system of the present invention includes a very brief descriptor of each object of the list. That brief descriptor may be text, graphics, or a combination thereof that gives an accurate description of the object while keeping the list in view. The brief descriptor is preferably provided by the posters of the objects on the list rather than by the varied outputs of a robot search. The very brief descriptor may be applied directly adjacent to the list object or it may be observed in a pop-up window when a cursor is dragged over it.

If the very brief descriptor triggers the accessor's or user's interest, the system provides a second-level summary descriptor that provides further information regarding an object of interest. The summary description, which may be a mini home page, is preferably provided by the source of the object of the list or directory of interest. It is further preferably provided in a condensed uniform form so that users can expect to learn the same type of information for each object of the list. All mini home pages launch at essentially the same rate, unlike existing browser-based processes wherein some object sites may be slower than others. Yet further, the improved directory system of the present invention is preferably configured so that multiple summary descriptions for a set of objects may be launched without loss of the ability to view the list. The mini home page may simply be a clipboard or a single-, or multi-page website-appearing page. The summary may be in the form of graphics, data, contact information, or anything else the source wishes to present to accessors. If and only if the system user remains interested in the named source, it can then access that source's site directly, such as through the mini home page. Clearly, this is an improved technique to enable users to access sites of interest only after reasonably certainty that the site is relevant

In the context of the present invention, the source of a particular object associated with a directory, a list or, more generally, content may be identified in a manner that provides users with information about the source of the object. For example, in the context of a forum, a posting that is a response to a prior posting may be tagged with a via link. The via link identifies the source or host through which the posting was generated. That via link may be configured to enable a user to learn information, such as by way of the very brief descriptor described above, about the source of the posting. That via link tagging may optionally further provide a way to access a mini home page associated with the source. In sum, the via link identifies the source of information related to the content. The system of the present invention generates such a source identifying via link when a posting is made to the unitary content via that source.

These and other advantages of the present invention will become apparent upon review of the following detailed description, the accompanying drawings, and the appended claims.

### BRIEF DESCRIPTION OF THE DRAWINGS

FIG. 1 is a simplified diagrammatic representation of the primary components of the distributed interactive content system of the present invention.

FIG. 2 is a simplified diagrammatic representation of the transactional server of the present invention.

FIG. 3 is a flow chart of the directory facilitator of the present invention.

FIG. 4 is a screen display of an exemplar mini home page generated by the website and mini-home page development system of the present invention.

FIG. 5 is a simplified block diagram of an optional filtering mechanism of the system of the present invention to enable host sites to administer the display of content information via their sites.

FIG. 6 is a screen display of an exemplar forum listing showing a via link to identify a posting source.

### DETAILED DESCRIPTION OF THE PREFERRED EMBODIMENTS Of THE INVENTION

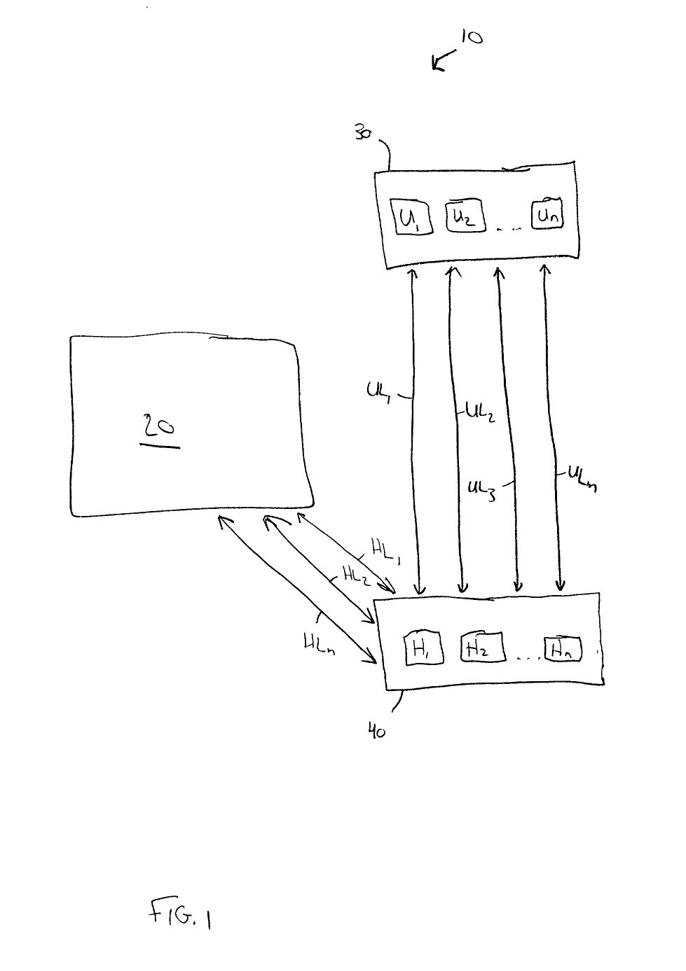

A first embodiment of the distributed interactive content system 10 of the present invention is shown in FIG. 1. Each of the components to be described herein is generally commercially available or is readily programmable by those skilled in the art. The system 10 involves the coupling of those components and associated software to enable interaction resulting in an accessible interactive content that may be accessed by any interested party, which party may modify the content through conventional computer-device-based interaction methods.

A primary component of the system 10 is a computing device that acts as a central network station or transactional server 20. The server 20 is preferably a computing device having mass storage capability, means for carrying out software-based instructions, and communicating systems for the exchange of signal transmissions among the server 20 and its users. The server 20 may be established as; a single device or a plurality of such devices coupled together in a distributed networking scheme. A central station or server may be employed to archive information associated with the content. It may also be employed to enable indexing of the content for searching. Alternatively, archiving may be achieved in a distributed format in that portions of content may be housed on one or more user and/or host sites, the accessing of which would be controlled through the transactional server 20.

The server 20 may be programmed to receive and store information related to one or more fields of interest provided by, and/or received from, users 30 through hosts 40. The number of users, represented as stations U₁, U₂, . . . , Uₙ, coupled to the server 20 is only limited by the network configuration through which they are coupled. Similarly, the number of hosts, represented as stations H, H₂, . . . , Hₙ, coupled to the server 20 is again only limited by the network configuration through which they are coupled. The users 30 and the hosts 40 are linked by conventional means including, but not limited to copper cable, optic cable, and wireless interfaces. Of course, the linkage may be through television and telephony as well as computing devices such as personal computers, personal digital assistants, and wireless telephony devices such as pagers, cellular phones, and the like. It is not limited solely to the types of interfacing devices enumerated herein.

The user-host links are represented figuratively in FIG. 1 as links UL₁, UL₂, UL₃ . . . , ULₙ, for links to the users 30, and as host-server links HL₁, HL₂, . . . , HLₙ, for links to the server 20. The users 30 are effectively linked to the server 20, as well as to each other and other hosts, if desired, through a selected host in a substantially transparent manner. That is, by substantially all appearances, a user remains on a selected host site while accessing the content that may be centralized at the server 20 or that may be accessed from a plurality of other sites via the server 20.

The server 20 is preferably programmed to receive communications from the users 30 via the hosts 40, to store information associated with those communications, and to transmit to the users 30 through the hosts 40 content information sought, subject to any security restrictions optionally imposed by a host. The server 20 may simply be a behind-the-scenes regulator of information transmission. It may also be a host and may further be associated with its own website. In that regard, it is to be noted that the hosts 40 themselves may or may not have their own websites.

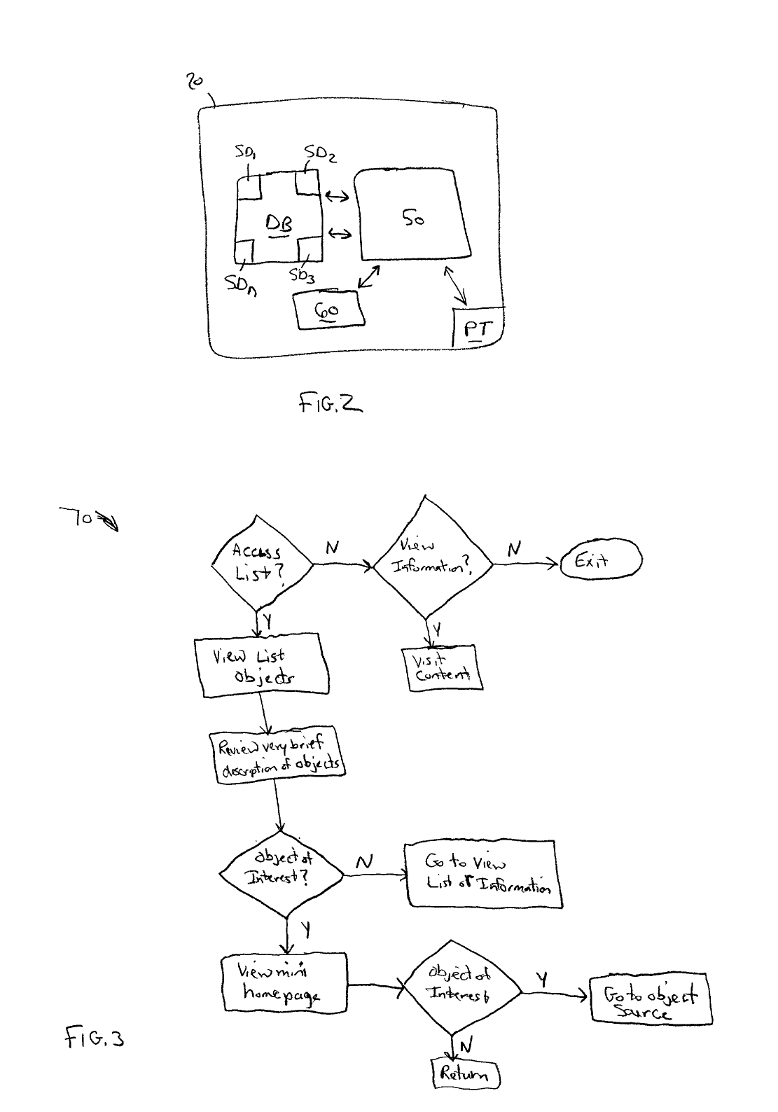

A simplified representation of important components of the server 20 is shown in FIG. 2. The server 20 includes a central processing unit (CPU) 50, a unitary content database DB including a plurality of subject matter subsets identified as subject databases SD₁, SD₂, SD₃, . . . , SDₙ, and an optional web site and mini page development sub-system 60. When content is created by the server 20 or received via the hosts 40, it is transmitted to the database DB such that it is substantially automatically updated. Any of the users 30 accessing the server 20 through any of the hosts 40 substantially immediately views updated content. The arrangement of a searchable and accessible database that may be manipulated by interaction with the users 30 is known to those skilled in the art.

Making the uniform database DB accessible by all connected hosts 40 provides those hosts with up-to-date content the depth of which could not otherwise be created by an individual host alone. The subject databases may be populated with forums, libraries, lists, or any other sort of element associated with the subject matter of interest. They may be cross-referenced, linked, or otherwise affiliated. One or more subject databases and portions thereof may be accessed and displayed through any suitable host. The information is unified in a single collection that may be distributed to all users. The information may be displayed in a variety of ways, selectable by the server 20, the users 30, the hosts 40, or any combination thereof. For example, some hosts may only want to show a portion and would therefore limit the display to that content it wishes to display.

The CPU 50 may be formed of a plurality of processing units near to, and remote from, one another. The information gathered by the CPU 50 is manipulated, organized and stored in the database DB in a manner that enables the users 30 and the providers 40 to interface with the station 20 to query it for retrieval of information. The manipulation of that information results in a unique database of content currently not available that is updated with each interaction and that is immediately available to all subscribing hosts. In effect, the server 20 is a routing, switching, data storage, and interface system. All communications with the various devices to which the server 20 is coupled may occur through wired or wireless, digital, analog, T1, T3, CAT5, frame-based data transport protocols, asynchronous mode transport protocols, or any other suitable electrical signal transport mechanism, or optical or propagated wave signal transport mechanism. That coupling is represented generically by port PT of the server 20 in FIG. 2. That coupling may include routing capabilities to enable the server 20 to provide web content to one or more of the hosts 40 for access by the users 30 and to enable interfacing of users 30 with one another through their hosts 40.

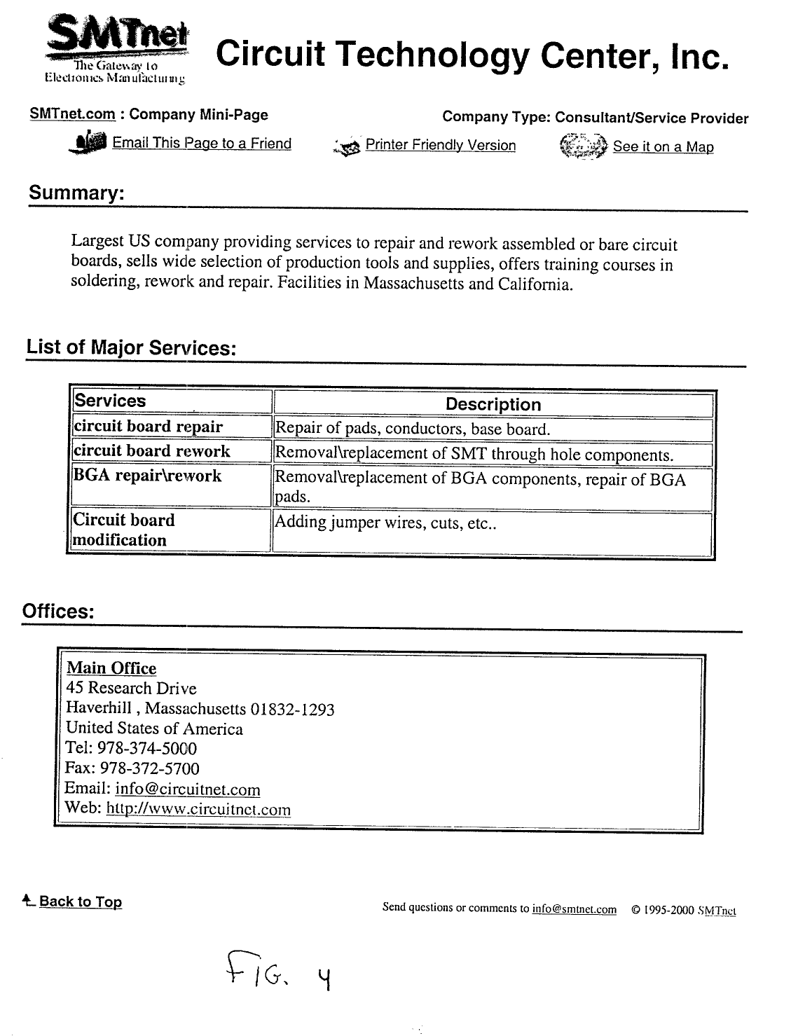

An optional feature of the system 10 of the present invention designed to facilitate a search and evaluation of objects of interest accessible through a computer network is shown in FIG. 3. A search facilitator system 70 preferably configured substantially in software includes a means by which users 30 can observe a directory or list of objects. The objects may be of anything one can contemplate users may be interested in learning about. That list may be generated by the server 20, one or more of the hosts 40, one or more of the users 30, or any combination thereof. The system 70 has broader application to any directory not specifically associated with the system 10 of the present invention but any directory or list of objects a user may wish to consider.

As part of the process enabled by the system 70, a user accesses a list of potential interest. A list of objects may be viewed, along with a very brief description of each object. The very brief description is preferably created by the source or a facilitator having some knowledge of the source. In one form of the system 70, the very brief description for each object is of a uniform form. The very brief description may be automatically displayed adjacent to the object as part of the list. Alternatively, the very brief description may be observed in other ways, such as a pop-up window launched when a cursor is passed over a particular object that may be observed as part of the list displayed, or any other means that may be associated with the array of display mechanisms available.

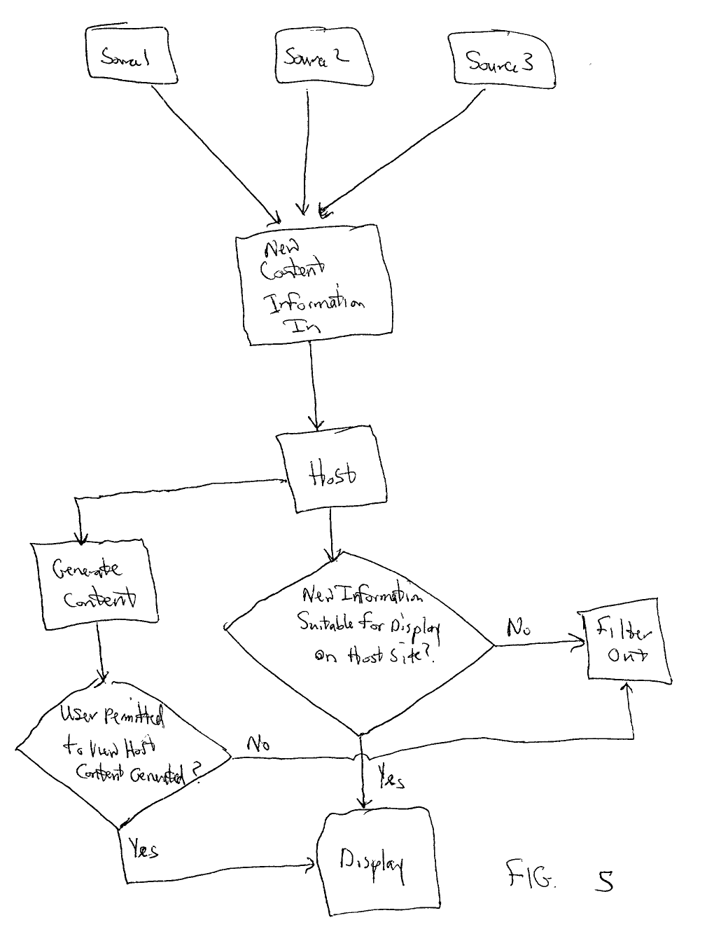

With continuing reference to FIG. 3, a user seeing a very brief description that appears to indicate that the object is of interest, may access a longer summary description of the object. One such summary description may be represented by a mini home page such as is shown in FIG. 4. Finally, if the summary description provides the type of information leading the user to wish to explore the object in greater detail, the user may access the object, such as a source website, directly. That may be arranged by adding an address link to the summary description.

As noted in regard to FIGS. 2 and 3, the summary description of an object of interest may be established with a mini home page. That mini home page may be created through the mini page development system 60 of server 20 but is not limited thereto. However, if it is used, the system 60 is configured to produce a mini home page of uniform appearance that launches in a relatively uniform period of time, regardless of the particular object selected. In that way, it eliminates the deviations in launch times and summary information that occurs when individual sources generate their own summaries and/or launching arrangements. The mini home page is preferably an exemplar of the source's own site but is not limited thereto. Formation of such a representation of a source is within the skill of website developers. An exemplar mini home page is represented by the display of FIG. 4.

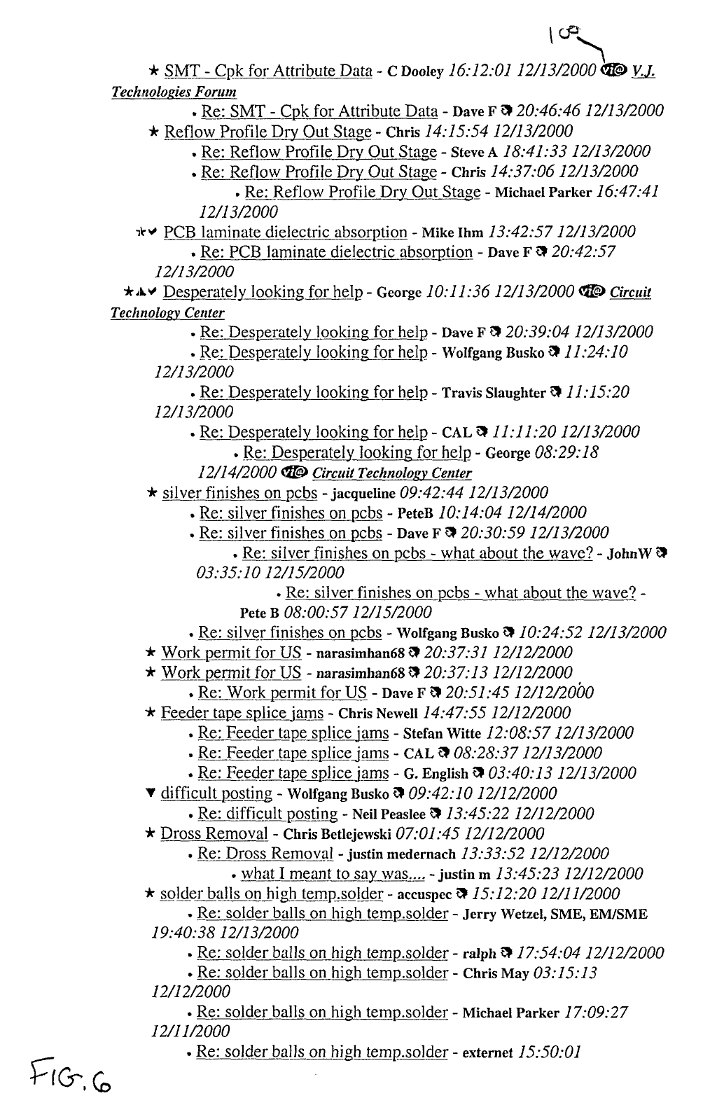

One optional feature of the software associated with the present invention is represented in FIG. 5. Specifically, the system may include application software to permit a host site to administer content displayed at its site. Two forms of such administration are shown in FIG. 5. First, information arriving to the singular content associated with particular subject matter is provided by any one or more of a plurality of sources to the host site. The software of the present invention enables the host to evaluate whether the new information is suitable for display via its site. If not, that particular information is filterable so that it may not be observed via the host site. If the host deems the new information to be acceptable, it can display the information. Second, the host may generate its own content information for posting. The host may make a determination that only certain users may access the information generated by the host and display accordingly. That determination may be based upon a requirement that interested users sign up as a subscriber to the site, for example.

As illustrated in FIG. 6, the source of a particular object associated with a list may be identified in a manner that provides users with information about the source of the object. For example, in the context of a forum, a posting that is a response to a prior posting may be tagged with a via link 100. The via link 100 identifies the source or host through which the posting was generated. That via link 100 may be configured to enable a user to learn information, such as by way of the very brief descriptor or the mini home page described above, about the source of the posting. The system of the present invention generates such a source identifying via link when a posting is made to the content via that source.

While the invention has been described with reference to a particular example embodiment, it is intended to cover all modifications and equivalents as described in the following claims.

What is claimed is:

1. A distributed interactive content system to enable interactive content exchange, the system comprising: software configured to enable reception, transmission, or both, of information related to one or more fields of interest and thereby generate content associated with each of said one or more fields of interest, wherein said content is accessible and modifiable by one or more users from any of one or more hosts such that said content is substantially uniform for all users and all hosts.

2. The system as claimed in claim 1 comprising a transactional server to receive and store said content, wherein said transactional server establishes an interface among said users and said hosts.

3. The system as claimed in claim 2 wherein said server further includes a uniform database including information related to one or more subjects of interest.

4. The system as claimed in claim 3 wherein said databases are supplied with said information from said one or more users and/or said one or more hosts.

5. The system as claimed in claim 3 further comprising means for exchanging information between said database and said one or more users via said one or more hosts.

6. The system as claimed in claim 3 wherein said network station further includes means to create a website and mini-page development sub-system.

7. The system as claimed in claim 6 wherein said website and mini-page development sub-system is configured to enable one or more of said users to view summary information of an object associated with a list, wherein said means to create said sub-system is configured to enable said one or more hosts to define related information regarding such hosts for insertion into a created mini home page.

8. The system as claimed in claim 2 further comprising means to couple said server to said hosts, wherein said means to couple includes wireless interfaces.

9. The system as claimed in claim 2 wherein said server is configured to manipulate, organize and store said information for retrieval by said users through said hosts such that said database can be queried for particular information to generate a unique database of content accessible by said users through said hosts.

10. The system as claimed in claim 1 wherein portions of said content may be stored in a distributed manner.

11. An interactive content system comprising:
a. means for accessing information associated with one or more subjects of interest;
b. means for establishing unified for each subject of interest;
c. means to enable access by one or more hosts to said content; and
d. means for one or more users to access and interact with said content via one or more of said hosts, wherein said one or more users may modify said content through interaction therewith.

12. A process to facilitate the review of a directory of one or more objects, the process comprising the steps of:
a. generating a very brief descriptor of information related to each of the one or more objects of the directory; and
b. generating a summary description of information related to selectable ones of the one or more objects, wherein said summary description may be in a uniform format for each of the one or more objects.

13. The process as claimed in claim 12 further comprising the step of enabling access via said summary description to a source of said summary description.

14. The process as claimed in claim 12 wherein said summary description is in the form of a mini home page.

15. The process as claimed in claim 14 further comprising the step of launching a plurality of said mini home pages while enabling viewing of the directory.

16. A mini home page system to provide a summary of the source of information associated with an object of an accessible directory, the mini home page system comprising a means for generating a summary display of information related to the source, wherein each mini home page for each object is of a substantially uniform type and may be launched within a substantially equivalent period of time for each object.

17. A via link system for automatically identifying a source of posting of information, the system comprising a tagging mechanism for automatically affiliating a source name and source access link with a posting upon posting of information.
